(19) United States
(12) Patent Application Publication
(10) Pub. No.: US 2026/0315313 A1
(43) Pub. Date: Oct. 15, 2026

(54) FOOT MASSAGE DEVICE

(71) Applicant: Shenzhen Faray InfoTech Co., Ltd., Shenzhen (CN)

(72) Inventor: Jinlong LIN, Shenzhen (CN)

(21) Appl. No.: 19/536,594

(22) Filed: Feb. 11, 2026

(30) Foreign Application Priority Data
Apr. 10, 2025 (CN) 202520676519.5
Apr. 10, 2025 (CN) 202530190809.4

(51) Int. Cl. A61H 15/00; A61H 7/00; A61H 23/00; A61H 23/02

(52) U.S. Cl. CPC A61H 15/0092; A61H 7/007; A61H 15/00; A61H 15/0078; A61H 23/006; A61H 23/0263; A61H 2201/0149; A61H 2201/149; A61H 2201/1669

(57) ABSTRACT

A foot massage device is provided. The foot massage device includes a housing defining an accommodating cavity and at least one opening in communication with the accommodating cavity and an external space of the housing; at least one foot receiving member arranged in the housing and configured for receiving the at least one foot; a first motor mounted in the housing; and at least one first massage member mounted in the housing and coupled to the first motor; when the at least one first massage member is driven by the first motor in a first mode, the at least one first massage member rotates around a first rotation axis and simultaneously reciprocates linearly along the first direction.

### CROSS-REFERENCE TO RELATED APPLICATIONS

The present application claims the benefit of and priority to Chinese Patent Application Serial No.202520676519.5, entitled “FOOT THERAPY MACHINE”, filed with China National Intellectual Property Administration (CNIPA) on Apr. 10, 2025, and Chinese Patent Application Serial No. 202530190809.4, entitled “FOOT THERAPY MACHINE”, filed with CNIPA on Apr. 10, 2025. The entire contents of all of the above-mentioned applications are hereby incorporated herein fully by reference into the present disclosure.

### TECHNICAL FIELD

The present disclosure relates to the field of health care equipment, in particular, to a massage device.

### BACKGROUND

With the continuous improvement of living standards, people pay more and more attention to their health. Therefore, various types of health care equipment have also become popular in people's life.

A conventional massage device typically use a single massage head to massage the forefoot of human. However, massage heads of the conventional massage device is fixedly disposed in a stationary position, such that the conventional massage device fails to provide a massaging action to additional regions of the forefoot.

### BRIEF DESCRIPTION OF DRAWINGS

In order to illustrate the technical solution in embodiments of the present disclosure more clearly, the following briefly introduces accompanying drawings used in the description of the embodiments. It should be noted that the accompanying drawings in the following descriptions cover only some embodiments of the present disclosure. Those of ordinary skill in the art may derive other drawings from these accompanying drawings without any creative efforts.

FIG. 1 is a three-dimensional structural diagram of a foot massage device according to an embodiment of the present disclosure.

FIG. 2 is a three-dimensional structural diagram of the foot massage device shown in FIG. 1, with an upper shell removed.

FIG. 3 is a three-dimensional structural diagram of the foot massage device shown in FIG. 2, with a pair of receiving members removed and a first massage structure located at a first position.

FIG. 4 is a three-dimensional structural diagram of the foot massage device shown in FIG. 2, with the pair of receiving members removed and the first massage structure is located at a second position.

FIG. 5 is a three-dimensional structural diagram of the foot massage device shown in FIG. 2, with one of the pair of receiving members and the first massage structure removed.

FIG. 6 is an enlarged schematic view of area A in FIG. 5.

FIG. 7 is a partial three-dimensional structural diagram of the foot massage device shown in FIG. 1.

FIG. 8 is a partial three-dimensional structural diagram of the foot massage device shown in FIG. 7, with a base of a sliding member removed.

FIG. 9 is a three-dimensional structural diagram of a first massage structure and a second massage structure of the foot massage device shown in FIG. 1.

FIG. 10 is a partial three-dimensional structural diagram of the first massage structure shown in FIG. 9.

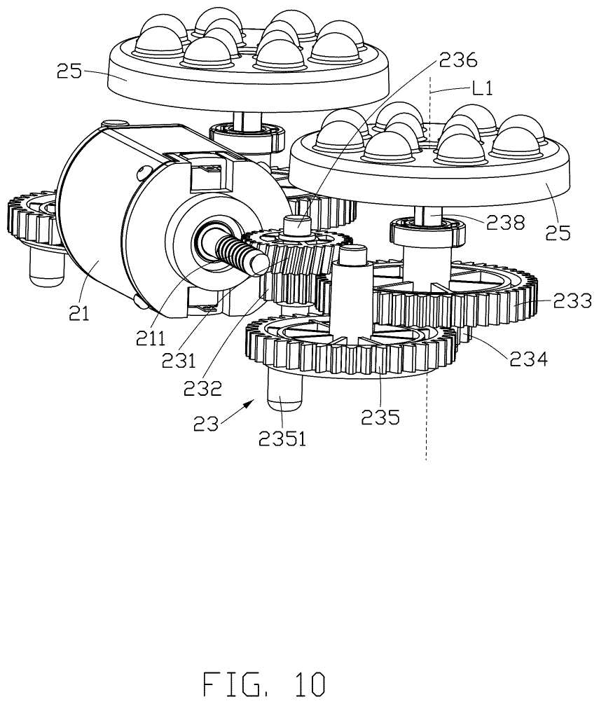

FIG. 11 is a partial three-dimensional structural diagram of the first massage structure shown in FIG. 9.

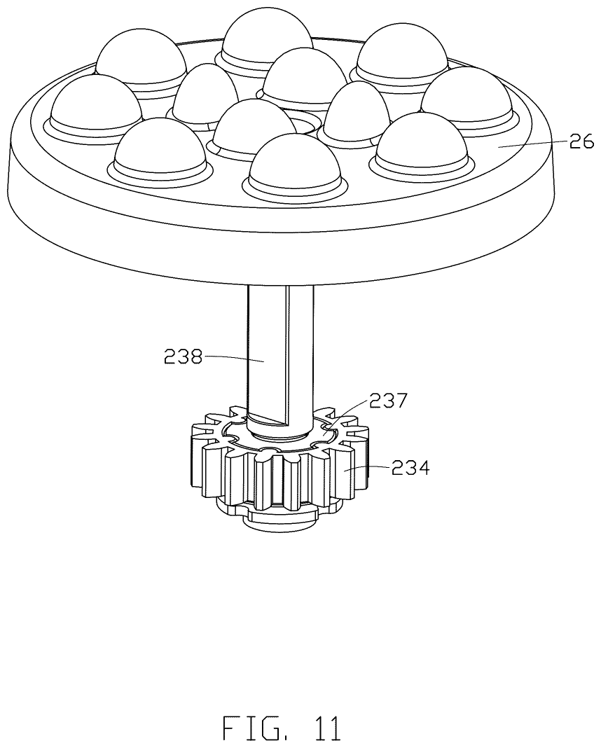

FIG. 12 is a three-dimensional structural diagram of a first massage structure of the foot massage device shown in FIG. 1.

FIG. 13 is an enlarged schematic view of area B in FIG. 5.

### DETAILED DESCRIPTION

To make the purpose, technical solutions and advantages of the present disclosure clearer, the technical solutions in the embodiments of the present disclosure will be described in more detail hereinafter in conjunction with the drawings in preferred embodiments of the present disclosure. In the drawings, the same or similar reference numerals denote the same or similar components or components having the same or similar functions throughout. The described embodiments are a part of embodiments of the present disclosure, not all thereof. The embodiments described hereinafter by referring to the figures are exemplary, and are intended to explain the present disclosure, and should not be construed as limiting the present disclosure. Based on the embodiments in the present disclosure, all other embodiments obtained by those skilled in the art without creative efforts fall within the claimed scope of the present disclosure. Hereinafter, embodiments of the present disclosure will be described in detail in conjunction with the accompanying drawings.

In the description of the present disclosure, it should be noted that, unless otherwise clearly stipulated and limited, the terms “installed”, “connected with” and “connected” should be understood in a broad sense. For example, they can be fixedly connected, or indirectly connected through an intermediate medium, which can be the internal communication of two elements or the interaction relationship between two elements. For those skilled in the art, the concrete meaning of the above-mentioned terms in the present disclosure can be understood under concrete circumstances.

In the description of the present disclosure, it should be understood that the orientation or positional relationship indicated by the terms “upper”, “lower”, “front”, “rear”, “vertical”, “horizontal”, “top”, “bottom”, “inner”, “outer” is based on the orientation or positional relationship shown in the drawings, and is only for the convenience of describing the present disclosure and simplifying the description, rather than indicating or implying that the referred device or element must include a specific orientation, constructed and operated in a particular orientation and therefore should not be understood as limiting the present disclosure.

The terms “first”, “second”, and “third” (if any) in the description, claims and the above drawings of the present disclosure are used to distinguish similar objects and not necessarily to describe a specific order or priority. It should be understood that the data thus used are interchangeable under appropriate circumstances such that the embodiments of the present disclosure described herein can be practiced in sequences other than those illustrated or described herein.

Furthermore, the terms “comprise”/“include” and “include”, as well as any variations thereof, are intended to cover a non-exclusive inclusion, for example, a process, method, system, product or maintenance tool comprising a series of steps or units need not be limited to the expressly listed, but other steps or elements not explicitly listed or inherent to the process, method, product or maintenance tool may be included.

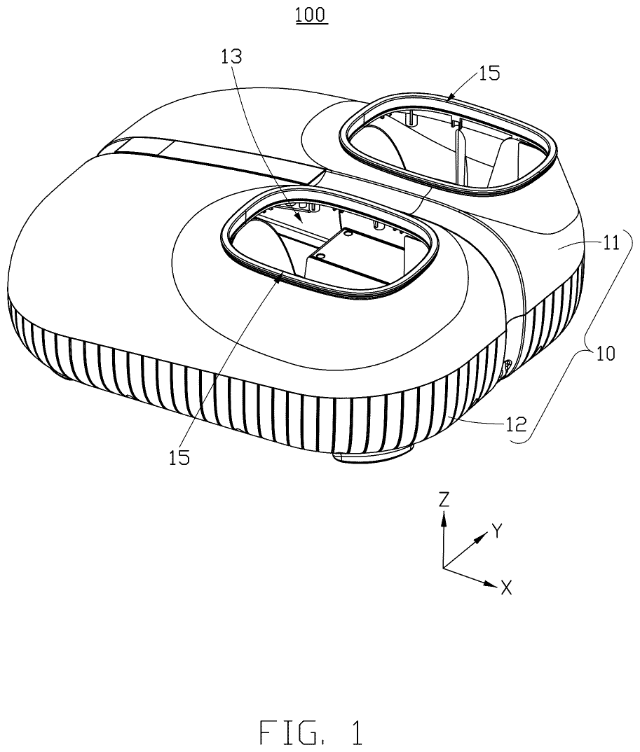

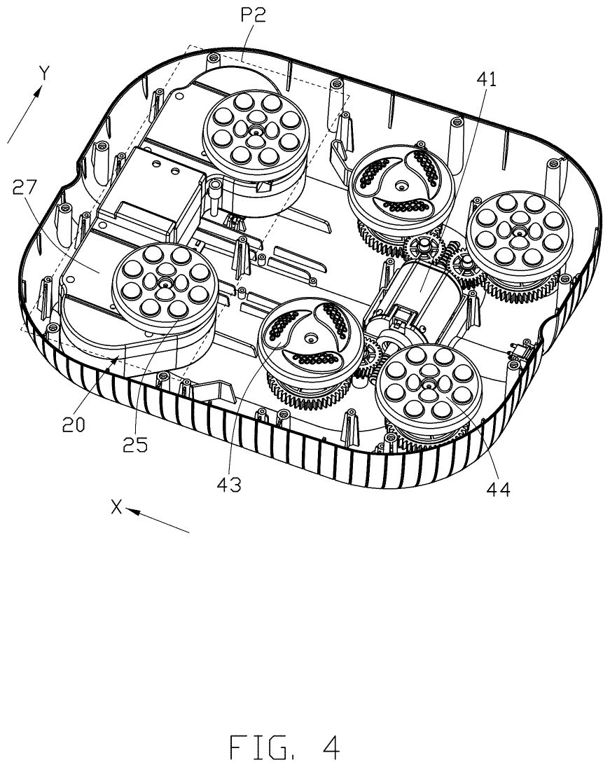

Referring to FIG. 1 to FIG. 5, the present disclosure provides a foot massage device 100 configured for massaging at least one foot of a human body. In this embodiment, the foot massage device 100 is configured for massaging feet. The foot massage device 100 includes a housing 10, a first massage structure 20 and a second massage structure 40. The first massage structure 20 is slidably accommodated inside the housing 10 and configured for slidably massaging a front portion of the foot. The second massage structure 40 is also received in the housing 10 and configured for massaging on a rear portion of the foot.

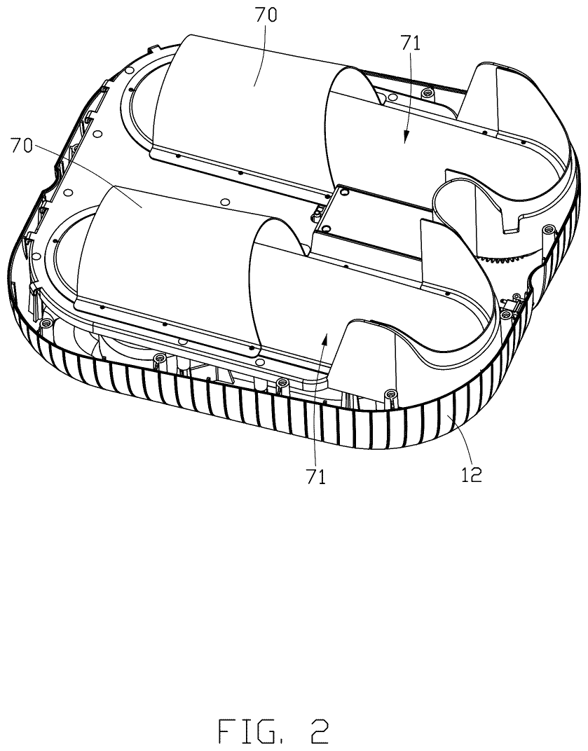

Referring to FIG. 1 to FIG. 2, the housing 10 includes an upper housing 11 and a lower housing 12 disposed opposite to the upper housing 11. The lower housing 12 and the upper housing 11 are assembled to form an accommodating cavity 13. The accommodating cavity 13 is configured to accommodate the first massage structure 20, the second massage structure 40 therein. The upper housing 11 is provided with at least one opening 15 which extends along a first direction X and communicates the accommodating cavity 13 with an external space out of the housing 10. The at least one opening 15 is configured to receive and accommodate the user's feet in the accommodating cavity 13, so as to receive massage operations from the corresponding massage structures. In this embodiment, the figure shows that the upper housing 11 is provided with two openings 15 to allow the user to insert his/her feet into the accommodating cavity 13. In another alternative embodiments, the upper housing 11 may also be provided with only one opening 15, through which the user can insert both feet into the accommodating cavity 13 for massage.

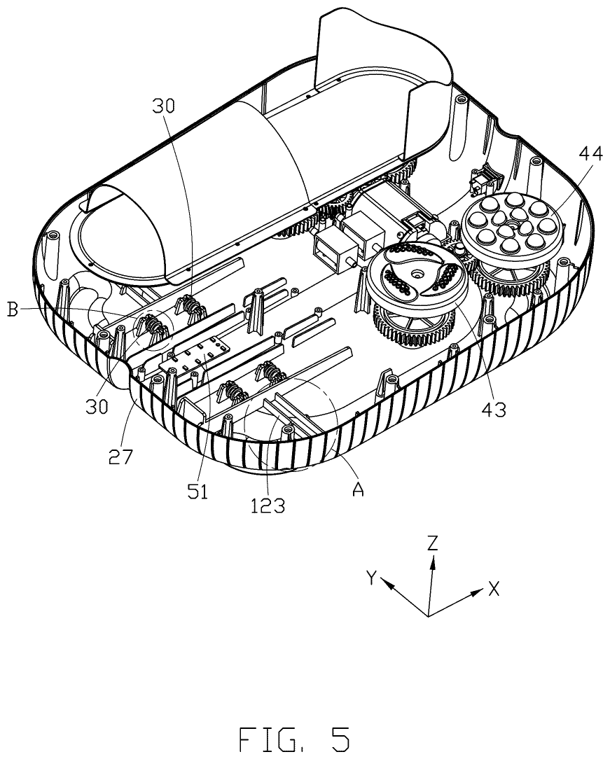

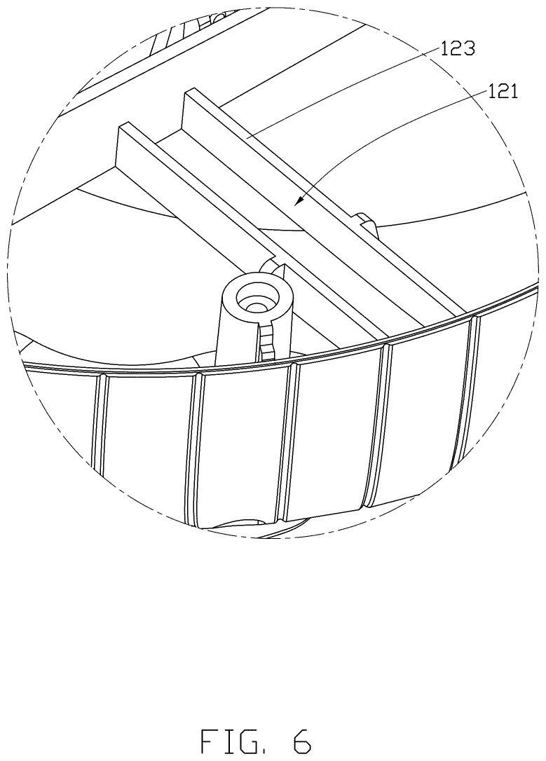

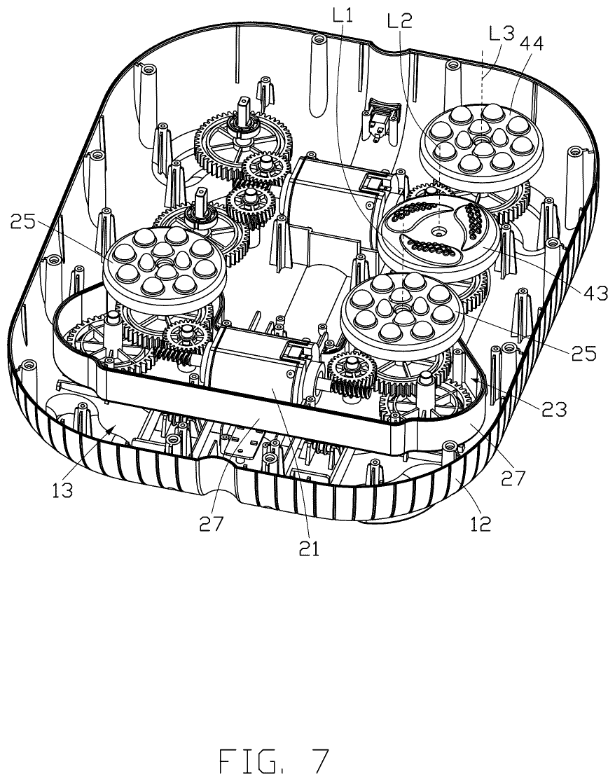

Referring to FIG. 5 to FIG. 8, a bottom wall of the lower housing 12 is provided with at least one limiting groove 121 extending along a second direction Y, the second direction Y is substantially perpendicular to a first direction X. Each limiting groove 121 is adapted to a later-described eccentric post 2351 of the first massage structure 20 to limit the movement trajectory of the eccentric post 2351.

In this embodiment, the bottom wall of the lower housing 12 is provided with at least one pair of guide ribs 123 extending along the second direction Y. Each limiting groove 121 is defined by a pair of guide ribs 123. In other embodiments, at least one limiting groove 121 may be directly recessed in the bottom wall of the lower housing 12, which is not limited herein.

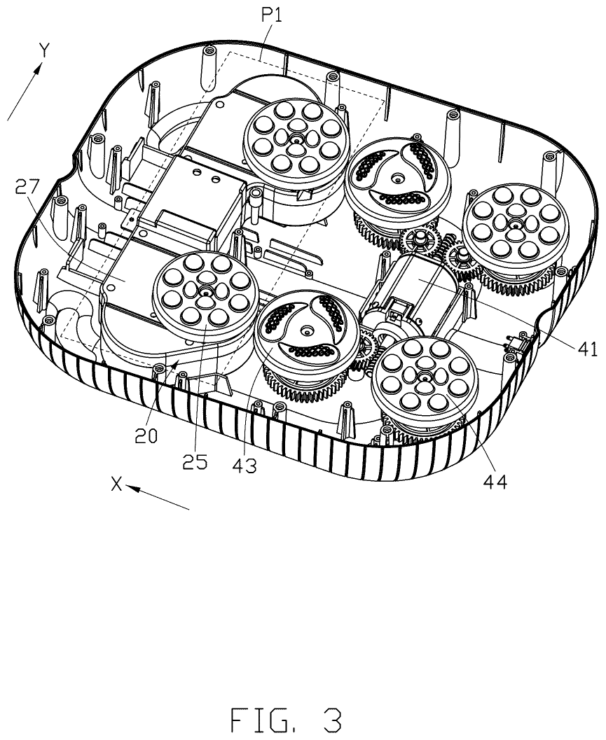

Referring to FIGS. 3-4 and 6-9, the first massage structure 20 is slidably disposed in the accommodating cavity 13 and can reciprocate along directions parallel to the first direction X between a first position P1 and a second position P2. In this embodiment, the first position P1 is a first limit position of the first massage structure 20 approaching the second massage structure 40 along the first direction X, and the second position P2 is a second limit position of the first massage structure 20 moving away from the second massage structure 40 along the first direction X.

The first massage structure 20 includes a first motor 21, at least one first transmission mechanism 23, at least one first massage member 25, and a sliding member 27. The sliding member 27 is slidably disposed in the accommodating cavity 13 and configured to reciprocate the directions parallel to the first direction X between the first position P1 and the second position P2. The first motor 21, the at least one first transmission mechanism 23, and the at least one first massage member 25 are disposed on the sliding member 27 and move synchronously with the sliding member 27. In this embodiment, to meet the requirement of synchronous massage for both feet, the first massage structure 20 includes two first transmission mechanisms 23 and two first massage members 25, each first transmission mechanism is coupled to the first motor 21 and a corresponding first massage member 25.

The first motor 21 is configured to provide rotational power. In this embodiment, the first motor 21 specifically adopts a double-headed motor. Opposite ends of the double-headed motor are respectively provided with two first output shafts 211. First output shafts 211 which are arranged on the ends are coaxially arranged and respectively coupled with the corresponding first transmission mechanisms 23. The rotations of the first output shafts 211 drive the first transmission mechanisms 23 to move, thereby driving the corresponding first massage members 25 to rotate.

In this embodiment, the first output shaft 211 may be a screw shaft, and an outer peripheral wall of the screw shaft is provided with engaging threads for meshing with a later-described worm gear 231 of the first transmission mechanism 23.

In other embodiments, the first output shaft 211 may also adopt a smooth shaft structure. A worm provided with engaging threads is coupled to the first output shaft 211 to realize the meshing transmission with the worm gear.

Each of the first transmission mechanism 23 is configured to transmit the power of the first motor 21 to the first massage member 25, and includes a worm gear 231, a first transmission gear 232, a second transmission gear 233, a third transmission gear 234, a guide gear 235, a rotating shaft 236, a one-way transmission member 237, and a driving arm 238. The rotating shaft 236 and the driving arm 238 are rotatably disposed on the sliding member 27. The first worm gear 231 is threadedly engaged with the first output shaft 211 to realize the transmission of rotational power from the first output shaft 211 to the first worm gear 231. The first transmission gear 232 and the first worm gear 231 are coaxially sleeved on the rotating shaft 236 and rotate synchronously with the first worm gear 231. The one-way transmission member 237 is sleeved on the driving arm 238 to realize one-way power transmission, that is, the driving power can be transmitted to the driving arm 238 when the first output shaft 211 rotates in a first rotation direction, and the power can't be transmitted to the driving arm 238 when the first output shaft 211 rotates in a second rotation direction, the second rotation direction is opposite to the first rotation direction. In this embodiment, the one-way transmission member 237 is a one-way bearing. The second transmission gear 233 is sleeved on the driving arm 238 and meshed with the first transmission gear 232. The third transmission gear 234 is sleeved on an outer periphery of the one-way transmission member 237 and is capable of rotating synchronously with the second transmission gear 233. The guide gear 235 is meshed with the third transmission gear 234 to realize power transmission to the guide gear 235.

In this embodiment, the guide gear 235 is provided with an eccentric post 2351 which extends along a third direction Z. The eccentric post 2351 performs an eccentric circular motion while the guide gear 235 rotates, the third direction Z is perpendicular to the first direction X and the second direction Y.

The sliding member 27 is slidably disposed in the accommodating cavity 13. Specifically, the sliding member 27 can do a reciprocating linear motion along the directions parallel to the first direction X, thereby driving the first massage member 25 to reciprocate synchronously along the first direction X to perform a sliding massage on the user's feet. In this embodiment, the sliding member 27 is provided with a through hole 260 for accommodating the guide gear 235. The eccentric post 2351 of the guide gear 235 passes through the through hole 260 and extends below the sliding member 27, and is slidably accommodated in the corresponding one of the at least one limiting groove 121. The movement of the eccentric post 2351 is limited by the limiting groove 121, so as to convert the circular moving motion of the eccentric post 2351 into the linear reciprocating motion of the sliding member 27. In other embodiments, the sliding member 27 may also be driven to slide back and forth by an air cylinder, an electric cylinder, or a motor alone. Therefore, the third transmission gear 234, the guide gear 235, the one-way transmission member 237 and the at least one limiting groove 121 constitute a conversion mechanism configured to convert a circular moving motion of the first motor 21 into a reciprocating motion of the sliding member 27 along the first direction X, so as to the at least one first massage member 25 is capable of reciprocating linearly along the directions parallel to the first direction X.

The first massage member 25 is disposed on the driving arm 238 and can rotate with the rotation of the driving arm 238 to massage the user's feet.

The power transmission and movement principle of the first massage structure 20 are as follows.

When the first output shaft 211 of the first motor 21 rotates along the first rotation direction, the first motor 21 drives the worm gear 231 to rotate. Since the first transmission gear 232 is coaxially fixed with the worm gear 231, the first transmission gear 232 is driven to rotate synchronously; the first transmission gear 232 drives the second transmission gear 233 to rotate by the gear meshing, the second transmission gear 233 then drives the first massage member 25 and the third transmission gear 234, which are coaxially arranged with it, to rotate synchronously. On the other hand, the third transmission gear 234 drives the guide gear 235 to rotate by the gear meshing. When the guide gear 235 rotates, the eccentric post 2351 of the guide gear 235 performs a circular moving motion. Due to the limiting effect of the limiting groove 121, the circular moving motion of the eccentric post 2351 drives the sliding member 27 to do the reciprocating movement along the first direction X. Thus, the sliding member 27 drives the first motor 21, the at least one first transmission mechanism 23 and the at least one first massage member 25 of the first massage structure 20 to reciprocate synchronously along the directions parallel to the first direction X, and at the same time, the first massage member 25 keeps rotating under the drive of the first motor 21, thereby realizing a combined massage action of rotation and reciprocating movement of the first massage member 25. This combined massage action can provide a larger area massaging effect.

When the first motor 21 rotates along the second rotation direction, the first output shaft 211 drives the worm gear 231, the first transmission gear 232, the second transmission gear 233, and the first massage member 25 to rotate, ensuring that the first massage member 25 keeps rotating. However, due to the idling of the one-way transmission member 237, when the first motor 21 rotates along the second rotation direction, the one-way transmission member 237 cannot transmit the power to the third transmission gear 234, so that the third transmission gear 234, the guide gear 235, and the eccentric post 2351 is stationary, and thus the eccentric post 2351 remains stationary in the limiting groove 121. At this time, the position of the first massage structure 20 in the first direction X remains unchanged. The first massage member 25 is just rotating without linearly moving, so that a fixed-point rotational massage effect is performed, which can perform a targeted massage on specific parts of the feet.

Therefore, by switching the forward and reverse directions (the first rotation direction and the second rotation direction) of the first motor 21, the foot massage device 100 can be selectively switched between the first mode and the second mode. In the first mode, the first output shaft 211 of the first motor 21 rotates along the first rotation direction, the first massage structure 20 reciprocates between the first position P1 and the second position P2 along the directions parallel to the first direction X, and the first massage member 25 rotates around a first rotation axis L1, so that a larger area of the forefeet can be covered, and the larger area massage is performed. In the second mode, the first output shaft 211 of the first motor 21 rotates along the second rotation direction, the position of the first massage member 25 in the first direction X remains being unchanged, and the first massage member 25 rotates around the first rotation axis L1 at a predefined position, which can perform the targeted massage on specific parts of the forefeet. Compared with the traditional devices that can only perform the fixed-point massage, the first massage structure 20 of the present disclosure has a higher massage flexibility, wider coverage, and stronger practicability.

Further, the sliding member 27 includes a base 271 and a cover 273. The base 271 and the cover 273 are connected to form an receiving portion 275 for accommodating the first motor 21 and the first transmission mechanism 23. The first motor 21 and the first transmission mechanism 23 can be protected by placing the first motor 21 and the first transmission mechanism 23 in the receiving portion 275. In addition, the first massage member 25 is exposed from the cover 273 to massage the user's feet.

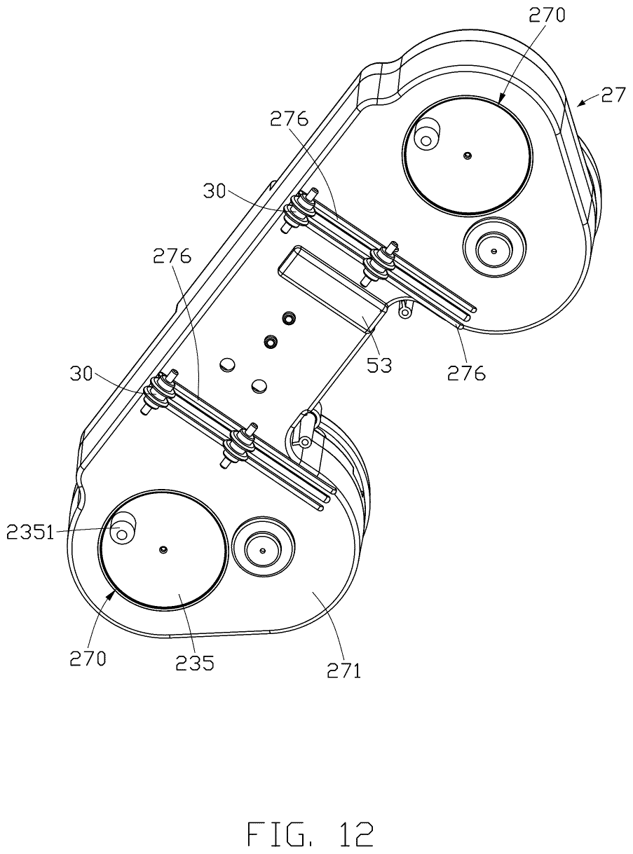

Referring to FIG. 12, To further ensure the smoothness and stability of the sliding of the sliding member 27, the bottom surface of the sliding member 27 is formed with at least one guiding portion 276, which is coupled to a rolling guide assembly 30 described later. In this embodiment, the guiding portion 276 is strip-shaped.

In this embodiment, the sliding member 27 includes a plurality of guiding portions 276, which are sequentially fixed to the bottom surface of the sliding member 27 along the first direction X and parallel to each other. Thus, a pair of guiding grooves 277 are defined by the guiding portions 276.

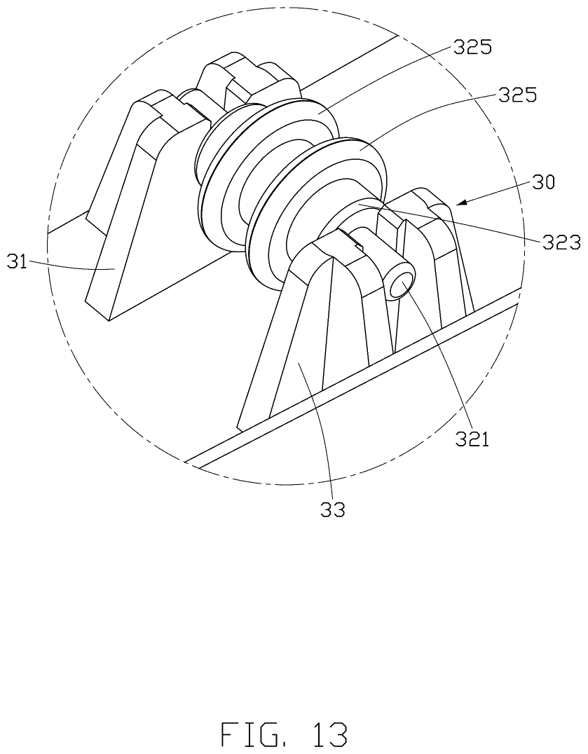

In this embodiment, referring to FIG. 13, the rolling guide assembly 30 disposed on a bottom wall of the accommodating cavity 13 and configured to guide the sliding member 27 reciprocating along the directions parallel to the first direction X. The rolling guide assembly 30 includes a first support member 31, a rotating member 32, and a second support member 33. The first support member 31 and the second support member 33 are fixed to the bottom wall of the accommodating cavity 13 and opposite to each other at the second direction Y.

The rotating member 32 includes a rotating shaft 321, a support portion 323, and a pair of wheels 325. Both ends of the rotating shaft 321 are rotatably connected to the first support member 31 and the second support member 33 through bearings respectively. The rotating support portion 323 is sleeved on the rotating shaft 321. The two wheels 325 are fixed on the rotating support portion 323 at intervals along the second direction Y, the wheels 325 are rollable in the guiding grooves 277, thereby reducing the contact friction force when the sliding member 27 moves relative to the housing 10.

In this embodiment, two rolling assemblies 30 are provided. The two rolling assemblies 30 are arranged at intervals along the first direction X and are both connected to the guiding portions 276 on the bottom surface of the sliding member 27. Through multiple sets of rolling fitting structures, on the one hand, the friction force produced by the motion of the sliding member 27 is reduced, so as to make slide more flexibly; on the other hand, the stability of the motion of the sliding member 27 is improved, so as to avoid tilting or jamming.

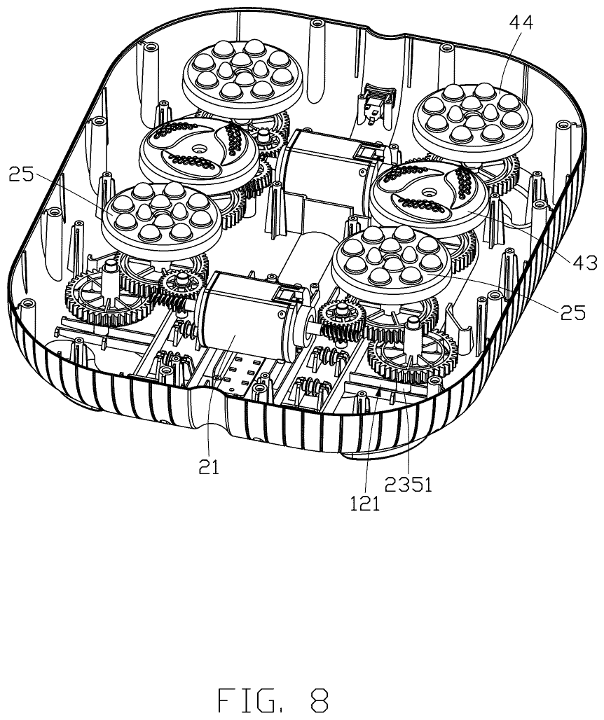

Referring to FIG. 8, the second massage structure 40 includes a second driving member 41, at least two second transmission mechanisms 42, at least one second massage member 43, and at least one third massage member 44.

The second driving member 41 is configured to provide rotational power required for massage. In this embodiment, the second driving member 41 is a double-headed motor, and second output shafts 411 are respectively provided on both sides of the double-headed motor. Similarly, the second output shaft 411 is a screw shaft, and is provided with engaging threads on the outer periphery.

In this embodiment, the second massage structure 40 includes four second transmission mechanisms 42, two second massage members 43, and two third massage members 44. One first massage member 25, one second massage member 43, and one third massage member 44 are located on one side of the foot massage device 100 and arranged in sequence along the first direction X, and the other first massage member 25, the other second massage member 43, and the other third massage member 44 are located on the other side of the foot massage device 100 and arranged in sequence along the first direction X, so that both feet can be massaged. In this embodiment, the first massage member 25 is configured to massage the toes and part of the sole, the second massage member 43 is capable of rotating about a second rotation axis L2 and configured to massage a sole of the foot, and the third massage member 44 is capable of rotating about a third rotation axis L2 and configured to massage a heel of the foot. In other embodiment, Either the second massage member 43 or the third massage member 44 may be omitted, with no limitation thereon in the present disclosure.

Two second transmission mechanisms 42 are located on both sides of one of the second output shafts 411, and the other two second transmission mechanisms 42 are located on both sides of the other second output shaft 411, so that each second output shaft 411 meshes with two transmission mechanisms 42 which are located at opposite sides of the second output shaft 411.

Among the two second transmission mechanisms 42 located on both sides of one of the second output shafts 411, one second transmission mechanism 42 is connected to the second massage member 43, and the other second transmission mechanism 42 is connected to the third massage member 44, so as to drive the second massage member 43 and the third massage member 44 to rotate respectively through the power transmission of the second transmission mechanism 42.

Among the two second transmission mechanisms 42 located on both sides of the other second output shaft 411, one second transmission mechanism 42 is connected to the other second massage member 43, and the other second transmission mechanism 42 is connected to the other third massage member 44, so as to drive the other second massage member 43 and the other third massage member 44 to rotate respectively through the power transmission of the second transmission mechanism 42. Thus, four massage members can be driven to rotate synchronously by the same motor, realizing multi-area massage while simplifying the structure, reducing the number of motors, and lowering the overall cost and volume of the device.

In this embodiment, the difference between the second transmission mechanism 42 and the first transmission mechanism 23 includes that the second transmission mechanism 42 does not need to realize the sliding function, therefore, the second transmission mechanism 42 does not include the third transmission gear 234, the one-way transmission member 237, and the guide gear 235. The composition and connection relationship of the other components (such as the worm gear, transmission gear, etc.) are the same as those of the first transmission mechanism 23, and the power transmission mode (rotational power transmission from the output shaft to the massage member) is also consistent with that of the first transmission mechanism 23, which can ensure the stable rotation of the second massage member 43 and the third massage member 44. Since the core transmission principle of the second transmission mechanism 42 is similar as that of the first transmission mechanism 23, the specific structure and transmission process thereof will not be repeated here.

A detection assembly is further provided in the housing to detect the position of the sliding member 27, so as to realize a precise control of the sliding position of the first massage structure 20.

Referring to FIGS. 5 and 12, the detection assembly includes a detector 51 and a trigger 53. The detector 51 is disposed on the bottom wall of the accommodating cavity 13 and corresponding to the first position P1 and the second position P2 of the sliding member 27. The trigger 53 is disposed on the sliding member 27. In this embodiment, numbers of both the detector 51 and the trigger 53 is one. In other embodiment, the numbers of both the detector 51 and the trigger 53 may be adjusted according to requirements, which are not limited herein. When the sliding member 27 moves to one of the first position P1 and the second position P2, the trigger 53 moves towards the detector 51, thereby triggering the detector 51 to detect a position of the sliding member 27, so as to drive the sliding member 27 to slide reversely, for example, the sliding member 27 moves to the other one of the first position P1 and the second position P2.

In some embodiments, the detector 51 is a proximity switch, such as a Hall effect switch, and the trigger 53 is a magnetic component. In other embodiments, the detector 51 can also use an infrared induction switch.

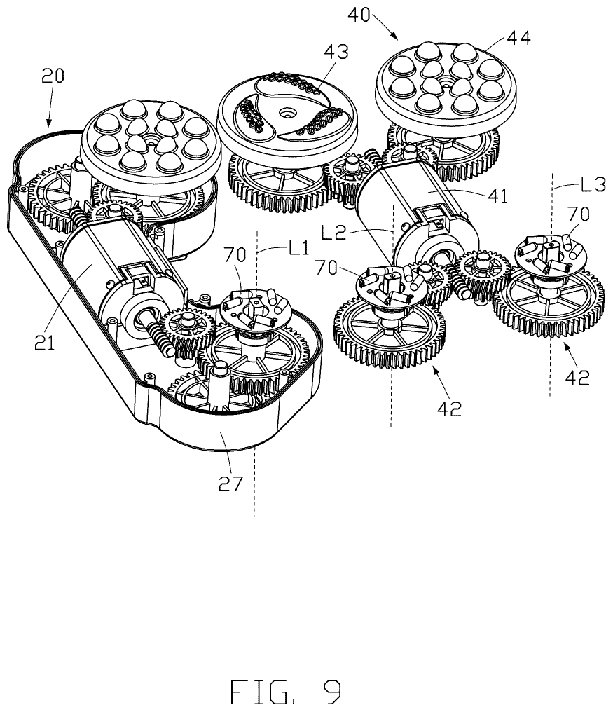

In this embodiment, referring to FIG. 9, the first massage member 25, the second massage member 43, and the third massage member 44 are provided with heating members 70 for heating the feet during the massage process, so that the foot massage device 100 has both massage and hot compress functions. The hot compress can promote blood circulation in the feet, relieve muscle tension, and further improve the massage effect. In some embodiments, the heating member 60 is a heating lamp.

A pair of foot receiving members 70 are located in the accommodating cavity 13 and above the first massage structure 20 and the second massage structure 40. Each foot receiving member defines an receiving portion 71 for accommodating the foot of user. The receiving portion 71 has a shape matching the foot. In this way, the foot can be placed in the receiving portion 71. During the massage process, the first massage member 25, the second massage member 43, and the third massage member 44 indirectly apply massage forces to the feet in the accommodating space. On the one hand, the foot receiving member 70 can buffer the direct pressure of the massage members on the feet, avoid discomfort caused by excessive massage force, and improve the use comfort; on the other hand, the foot receiving member 70 can prevent the massage members from directly contacting the soles of the feet, prevent the massage members from scratching the skin of the feet, and ensure the use safety. In this embodiment, the foot receiving member 70 is a massage airbag.

1. A foot massage device configured for massaging at least one foot, and comprising:
a housing defining an accommodating cavity and at least one opening wherein the at least one opening is in communication with the accommodating cavity and an external space out of the housing, and configured to receive and accommodate the at least one foot in the accommodating cavity;
at least one foot receiving member arranged in the housing and configured for receiving the at least one foot, each of the at least one foot receiving member extending along a first direction and comprising a first area corresponding to a front portion of the at least one foot, and a second area corresponding to a rear portion of the at least one foot;
a first motor mounted in the housing; and
at least one first massage member mounted in the housing and coupled to the first motor, each of the at least one first massage member corresponding to one of the first area and the second area;
wherein in a case that the at least one first massage member is driven by the first motor in a first mode, the at least one first massage member simultaneously rotates around a first rotation axis and reciprocates along directions parallel to the first direction.

2. The foot massage device according to claim 1, wherein in a case that the at least one first massage member is driven by the first motor in a second mode, the at least one first massage member rotates around the first rotation axis at a predefined position.

3. The foot massage device according to claim 2, further comprising a sliding member slidably disposed in the accommodating cavity and configured to reciprocate linearly along the directions parallel to the first direction, wherein the first motor and the at least one first massage member are mounted on the sliding member and moves synchronously with the sliding member.

4. The foot massage device according to claim 3, further comprising a rolling guide assembly disposed on a bottom wall of the accommodating cavity and configured to guide the sliding member reciprocating along the directions parallel to the first direction;
wherein the sliding member comprises at least one guiding portion arranged at a bottom surface of the sliding member along the first direction, the at least one guiding portion is coupled to the rolling guide assembly.

5. The foot massage device according to claim 4, wherein the rolling guide assembly comprises a first support member, a rotating member, and a second support member, the first support member and the second support member are spaced apart on the bottom wall in a second direction, the second direction is substantially perpendicular to the first direction,
two ends of the rotating member is rotatably connected to the first support member and the second support member, respectively, and the at least one guiding portion is slidably connected to the rotating member.

6. The foot massage device according to claim 5, wherein the sliding member comprises a plurality of guiding portions arranged parallel to each other, and at least one guiding groove is defined by the plurality of guiding portions,
the rotating member comprises at least one wheel each rollable in a corresponding guiding groove of the at least one guiding groove.

7. The foot massage device according to claim 3, further comprising at least one conversion mechanism configured to convert a circular moving motion of the first motor into reciprocating motions of the sliding member along the directions parallel to the first direction, in response to the sliding member reciprocates along the directions parallel to the first direction, the at least one first massage member driven to reciprocate along the directions parallel to the first direction.

8. The foot massage device according to claim 7, wherein each of the at least one conversion mechanism comprises:
at least one limiting groove defined on a bottom wall of the housing and extended along a second direction, the second direction is substantially perpendicular to the first direction, and
at least one guide gear arranged on the sliding member and coupled to the first motor and a corresponding first message member of the at least one first message member, the at least one guide gear comprising an eccentric post extending along a third direction and slidably received in a corresponding limiting groove of the at least one limiting groove, thereby converting a circular moving motion of the eccentric post driven by the guide gear into a reciprocating motion of the sliding member along the first direction, the third direction is perpendicular to both the first direction and the second direction.

9. The foot massage device according to claim 8, wherein each of the at least one conversion mechanism further comprises:
a driving arm coupled to the first motor, one end of the driving arm is rotatably disposed on the sliding member, another end of the driving arm is fixedly connected to the corresponding first massage member,
a one-way transmission member sleeved on the driving arm, and
a third transmission gear sleeved on an outer periphery of the one-way transmission member and meshed with the at least one guide gear,
in response to the at least one first massage member driven by the first motor in a first mode, the at least one guide gear rotates is driven by the third transmission gear and drives the sliding member to reciprocate along the first direction by the eccentric post sliding in the corresponding limiting groove, thereby the at least one first massage member simultaneously rotates around the first rotation axis and reciprocates along the first direction;
in response to the at least one first massage member driven by the first motor in a second mode, the one-way transmission member idles, the third transmission gear and the at least one guide gear is stationary, and the sliding member stops moving in the first direction, the at least one first massage member stops reciprocating in the first direction, remains at one position, and rotates around the first rotation axis.

10. The foot massage device according to claim 7, wherein the first motor comprises at least one output shaft, an outer peripheral wall of the at least one output shaft defines threads,
the foot massage device further comprises at least one first transmission mechanism coupled to a corresponding output shaft of the at least one output shaft and configured to transmit power of the first motor to the at least one first massage member, each of the at least one first transmission mechanism further comprises:
a worm gear meshing with the threads of the at least one output shaft;
a first transmission gear coaxially and fixedly disposed with the worm gear;
a second transmission gear meshing with the first transmission gear and sleeved on the driving arm to drive the at least one first massage member to rotate around the first rotation axis.

11. The foot massage device according to claim 3, further comprising a detection assembly, the detection assembly comprising:
a detector disposed on a bottom wall of the accommodating cavity; and
a trigger disposed on the sliding member,
wherein in response to the sliding member moving to one of the first position and the second position, the trigger moves towards the detector and triggers the detector to detect a position of the sliding member, so as to drive the sliding member to slide reversely.

12. The foot massage device according to claim 1, further comprising:
a second motor arranged in the housing; and
at least one second massage member mounted in the housing and coupled to the second motor, each of the at least one second massage member corresponding to the other one of the first area and the second area,
wherein in response the at least one second massage member is driven by the second motor, the at least one second massage member rotates around a second rotation axis, the second rotation axis is parallel to the first rotation axis.

13. A foot massage device configured for massaging at least one foot, comprising:
a housing defining an accommodating cavity and at least one opening, wherein the at least one opening extends along a first direction and is in communication with the accommodating cavity and an external space out of the housing, and configured to receive and accommodate the at least one foot in the accommodating cavity;
a first massage structure disposed in the accommodating cavity and configured to be capable of reciprocating along directions parallel to the first direction between a first position and a second position, the first massage structure comprising at least one first massage member corresponding to a portion of the at least one foot; and
a second massage structure disposed in the accommodating cavity and spaced apart from the first massage structure along the first direction, the second massage structure comprising at least one second massage member corresponding to the other portion of the at least one foot;
wherein the foot massage device is switchable between a first mode and a second mode, in the first mode, the first massage structure reciprocates along directions parallel to the first direction to approach or move away from the second massage structure, and the first massage member rotates around a first rotation axis; in the second mode, the first massage member rotates around the first rotation axis at a predefined position.

14. The foot massage device according to claim 13, wherein the first massage structure comprises:
a sliding member slidably disposed in the accommodating cavity and configured to reciprocates linearly between the first position and the second position;
a first motor disposed on the sliding member;
the at least one first massage member arranged on the sliding member and coupled to the first motor, wherein the at least one first massage member moves in tandem with the sliding member, so as to deliver a sliding massage to the at least one foot.

15. The foot massage device according to claim 14, further comprising a rolling guide assembly disposed on a bottom wall of the accommodating cavity and configured to guide the sliding member reciprocating along the directions parallel to the first direction;
the sliding member comprises at least one guiding portion arranged at a bottom surface of the sliding member along the first direction, the at least one guiding portion is coupled to the rolling guide assembly.

16. The foot massage device according to claim 15, wherein the rolling guide assembly comprises a first support member, a rotating member, and a second support member, the first support member and the second support member are spaced apart on the bottom wall at a second direction, the second direction is substantially perpendicular to the first direction,
two ends of the rotating member is rotatably connected to the first support member and the second support member, respectively, and the at least one guiding portion is slidably connected to the rotating member.

17. The foot massage device according to claim 16, wherein the sliding member comprises a plurality of guiding portions arranged parallel to each other, and at least one guiding groove is defined by the plurality of guiding portions,
the rotating member comprises at least one wheel each rollable in a corresponding guiding groove of the at least one guiding groove.

18. The foot massage device according to claim 17, wherein the first massage structure further comprises a first motor mounted on the sliding member, and at least one first transmission mechanism coupled to the first motor and configured to transmit a power of the first motor to the at least one first massage member.

19. The foot massage device according to claim 18, wherein the housing comprises at least one limiting groove defined on a bottom wall of the housing and extended along a second direction, the second direction is substantially perpendicular to the first direction,
each of the at least one first transmission mechanism includes a guide gear coupled to an output shaft of the first motor, the guide gear is provided with an eccentric post, the eccentric post extending along a third direction and slidably received in a corresponding limiting groove of the at least one limiting groove, thereby converting circular moving motion of the eccentric post driven by the guide gear into reciprocating movement of the sliding member along the directions parallel to the first direction, the third direction is perpendicular to both the first direction and the second direction.

20. The foot massage device according to claim 18, wherein each of the at least one first transmission mechanism further comprises a driving arm and a one-way transmission member,
one end of the driving arm is rotatably disposed on the sliding member, another end of the driving arm is fixedly connected to the corresponding one of the at least one first massage member,
the one-way transmission member is coupled to the driving arm, and the guide gear is coupled to the one-way transmission member;
when the at least one first massage member is driven by the first motor in a first mode, the guide gear rotates and drives the sliding member to do a reciprocating movement along the directions parallel to the first direction by cooperation between the eccentric post and the limiting groove, so as to the at least one first massage member rotates around the rotation axis and linearly reciprocates simultaneously;
in response to the at least one first massage member driven by the first motor in a second mode, the one-way transmission member idles, the guide gear is stationary, and the sliding member stops moving in the first direction, the first massage structure stops reciprocating, remains at one position, and rotates around the first rotation axis.
